(19) United States
(12) Patent Application Publication
(10) Pub. No.: US 2009/0106454 A1
(43) Pub. Date: Apr. 23, 2009

(54) INDEPENDENT SYNCHRONIZATION OF META-DATA BETWEEN DEVICES

(76) Inventors: DAVID A. GIRLE, Phoenix, AZ (US); ASHOK C. MAMMEN, Bangalore (IN)

Correspondence Address: IBM AUSTIN IPLAW (DG), C/O DELIZIO GILLIAM, PLLC, 15201 MASON ROAD, SUITE 1000-312, CYPRESS, TX, 77433, US

(21) Appl. No.: 11/873,910

(22) Filed: Oct. 17, 2007

(51) Int. Cl. G06F 15/16

(52) U.S. Cl. 709/248

(57) ABSTRACT

A method comprises maintaining a data store of meta-data for a plurality of other data stores. The meta-data data store includes a plurality of meta-data data elements. Each of the meta-data data elements corresponds to a respective one of a plurality of data stores on a first network element. Meta-data of the meta-data data store of the first network element is sent to a second network element. To synchronize the meta-data of one of the plurality of data stores, the meta-data data element of the meta-data data store that corresponds to that one of the plurality of data stores is synchronized between the first network element and the second network element. The synchronizing of the meta-data data element is independent of synchronizing of at least one of the plurality of data stores.

### FIELD

Embodiments of the invention(s) generally relate to the field of meta-data, and, more particularly, to synchronizing meta-data of meta-data data stores on different devices.

### BACKGROUND

The Open Mobile Alliance (OMA) Data Synchronization protocol is fast becoming the industry standard for data synchronization. The OMA Data Synchronization protocol was initially designed for the synchronization of mobile devices with limited resources and a small number of data stores. As mobile devices get more powerful and as the protocol enters the desktop synchronization arena, the number of synchronizable data stores becomes much larger. The OMA Data Synchronization protocol requires that both the client and server exchange meta-data of all of their data stores during the first synchronization session. Similarly, meta-data for all of the data stores are exchanged in a subsequent session even if the meta-data for only one of the data stores changes. This meta-data is communicated using an XML document whose DTD is defined by the OMA Data Synchronization specifications.

### SUMMARY

A method comprises maintaining a data store of meta-data for a plurality of other data stores. The meta-data data store includes a plurality of meta-data data elements. Each of the meta-data data elements corresponds to a respective one of a plurality of data stores on a first network element. Meta-data of the meta-data data store of the first network element is sent to a second network element. To synchronize the meta-data of one of the plurality of data stores, the meta-data data element of the meta-data data store that corresponds to that one of the plurality of data stores is synchronized between the first network element and the second network element. The synchronizing of the meta-data data element is independent of synchronizing of at least one of the plurality of data stores.

### BRIEF DESCRIPTION OF THE DRAWINGS

The present invention may be better understood, and its numerous objects, features, and advantages made apparent to those skilled in the art by referencing the accompanying drawings.

FIG. 1 depicts an example device that hosts a meta-data data store.

FIG. 2 depicts example data synchronization between a client and a server.

FIG. 3 depicts an example exchange between devices for data synchronization.

FIG. 4 depicts an example device.

### DESCRIPTION OF EMBODIMENT(S)

The description that follows includes exemplary systems, methods, techniques, instruction sequences and computer program products that embody techniques of the present invention. However, it is understood that the described invention may be practiced without these specific details. For instance, although examples refer to synchronizing over a network (e.g., LAN, WAN, etc.) or wirelessly between devices, data may be synchronized with other techniques (e.g., plugging in a flash memory card or stick, connecting devices directly with a cable, etc.). In other instances, well-known instruction instances, protocols, structures and techniques have not been shown in detail in order not to obfuscate the description.

In the following description, the terms “device” and “network element” are used. Examples of a device or network element include personal data assistants, cellular phones, portable game devices, computers, etc. Although embodiments are described herein with reference to a client and a server, the descriptions of examples should not be interpreted to limit the terms device and network element. A device or network element may operate as a client and/or a server. In addition, devices or network elements may synchronize as peers. For instance, mobile communication devices may synchronize data between them, as well as mobile communication devices synchronizing with one or more servers.

Transmitting all meta-data for all data stores supported on a device during data synchronization consumes more bandwidth and device resources than necessary. Bandwidth and device resources become scarcer as device information expands. Wasteful consumption of bandwidth and device resources becomes more substantial when considered within the context of a single server synchronizing with several hundred, or even a thousand, clients. Synchronizing meta-data between devices with a meta-data data store independent of synchronizing other data stores allows for efficient exchange between devices and reduces the consumption of bandwidth and device resources.

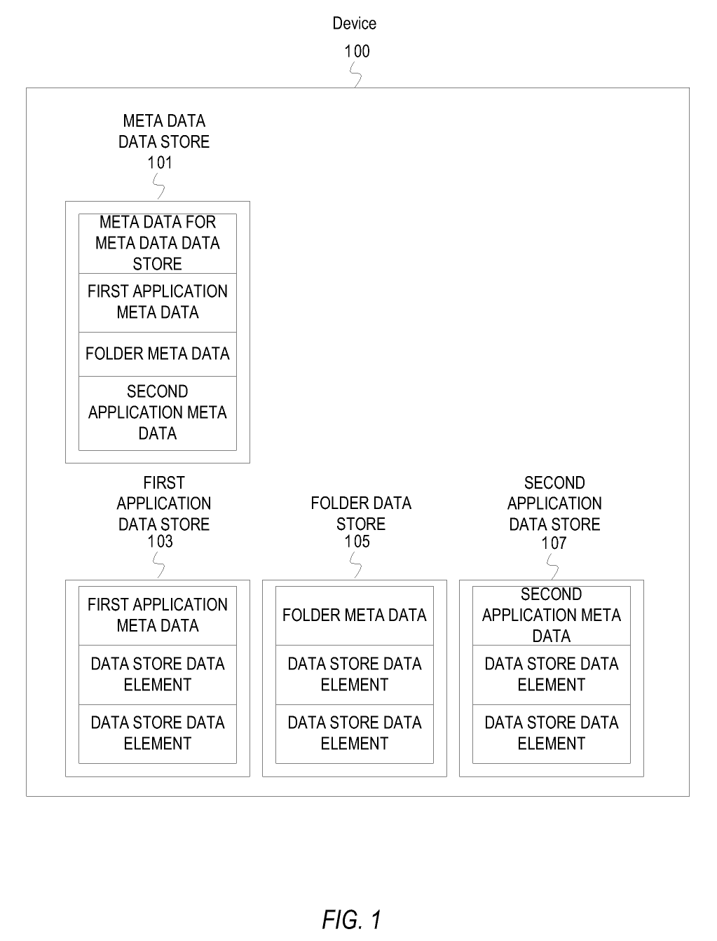

FIG. 1 depicts an example device that hosts a meta-data data store. A device 100 hosts a first application data store 103, a second application data store, 107, a folder data store 105, and a meta-data data store 101. Examples of applications that may be supported by the device 100 include a calendar application, address book application, game application, word processor application, etc. The first application data store 103 includes meta-data and data elements for a first application supported by the device 100. The second application data store 107 includes meta-data and data elements for a second application supported by the device 100. The folder data store 105 includes meta-data and data elements for a folder supported by the device 100.

The meta-data data store 101 includes meta-data and data elements for the meta-data store 101. Maintaining this separate data store of meta data for other data stores allow for efficient data synchronization when the device 100 synchronizes with another device. Each of the data elements of the meta-data data store 100 corresponds to a respective one of the data stores 103, 105, and 107. The meta-data data store 100 indicates the meta-data for the first application, the meta-data for the second application, and the meta-data for the folder. The meta-data data store 100 may include meta-data for the device 100 as another data element or within the meta-data for the meta-data data store 101. It should be appreciated that the meta-data data store 101 may be implemented in accordance with a variety of techniques. For example, the meta-data data store 101 may indicate meta-data by referencing (e.g., a pointer, index, etc.) the meta-data of the other data stores. The meta-data data store 101 may also indicate meta-data of other stores literally, as well as referentially. The meta-data data store 101 may also compress meta-data of the data stores.

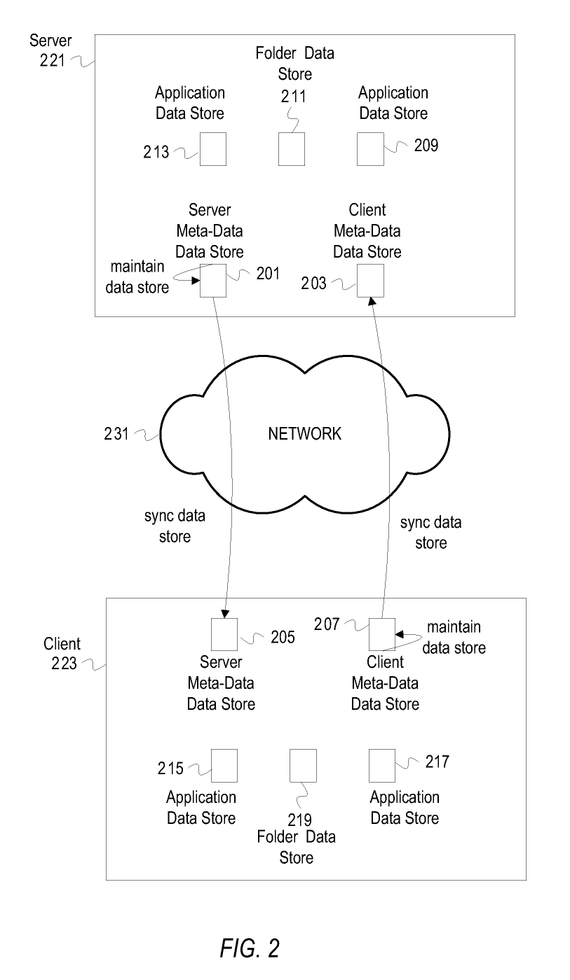

FIG. 2 depicts example data synchronization between a client and a server. A server 221 hosts application data stores 209 and 213, a folder data store 211, a server meta-data data store 201, and a client meta-data data store 203. The server 221 maintains the server meta-data data store 201 (e.g., adds data elements, deletes data elements, modifies data elements, etc.). Changes to the server meta-data data store 201 may also affect the client meta-data data store 203.

A client 223 hosts application data stores 215 and 217, a folder data store 219, a server meta-data data store 205, and a client meta-data data store 207. The client 223 maintains the client meta-data data store 207. Changes to the client meta-data data store 207 may affect the server meta-data data store 205.

The client 223 and the server 221 communicate via a network 231. Synchronization of data between the client 223 and the server 221 may be automatically initiated (e.g., periodically, responsive to a detected modification, responsive to a particular operation, etc.) and may be manually initiated. Regardless of which device requests synchronization, the client meta-data data store 203 on the server 221 is synchronized with the client meta-data data store 207 on the client 223 at some point. Likewise, the server meta-data data store 205 on the client 223 is synchronized with the server meta-data store 201 on the server 221 at some point. The meta-data data stores 201, 203, 205, and 207 are synchronized independent of the other data stores 209, 211, 213, 215, 217, 219. Meta-data for a data store may be modified, while the data elements of the data store are not modified. In this situation, the meta-data can be synchronized without exchanging data elements of the data store. Conversely, a data element of a data store may be modified without any change to the meta-data of the data store. With independent synchronization, the data store can be synchronized between devices without consuming bandwidth and device resources with exchanging meta-data of all data stores, which have not changed.

To illustrate, assume a data element in the application data store 215 has been modified, but the meta-data for the application data store 215 has not been affected. Independent synchronization of meta-data allows the application data store 215 to be synchronized with the application data store 213 (assuming the application data stores 213 and 215 correspond to the same application) without transmitting meta data of the data stores 217 and 219, as well as the meta-data for the data store 215.

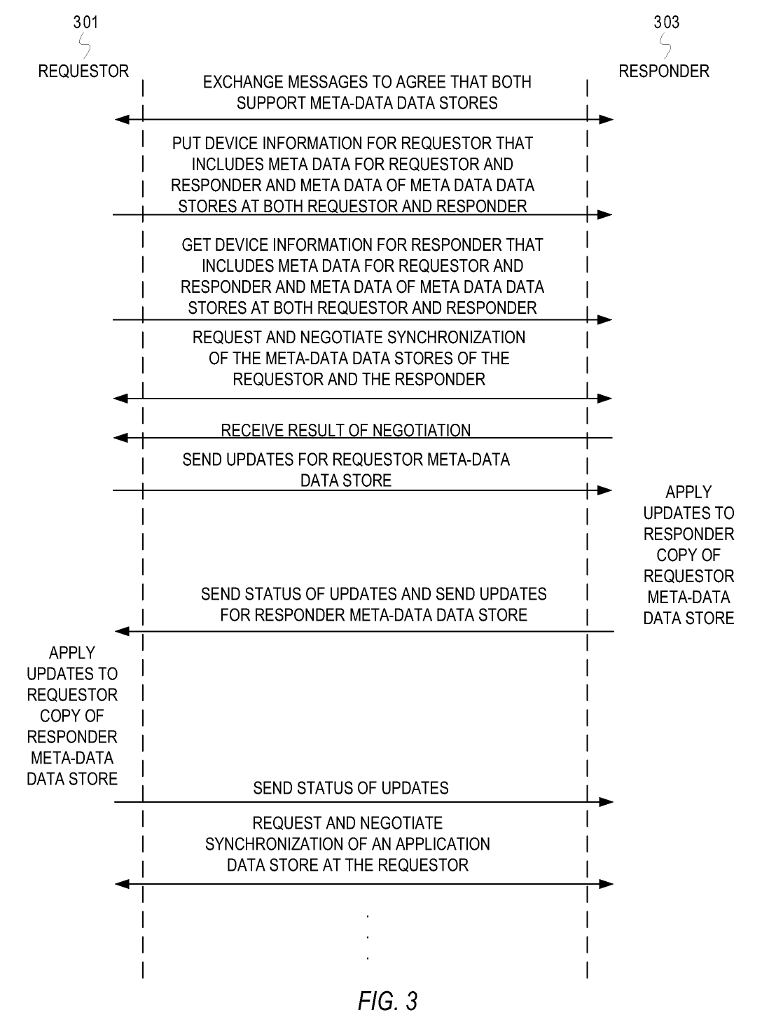

FIG. 3 depicts an example exchange between devices for data synchronization. A requestor 301 and a responder 303 exchange messages to agree that the devices, or network elements, support meta-data data stores. The monikers “requestor” and “responder” are used to distinguish the devices without the burden of client and server labels. The distinction in this example illustration is based on which device initiates synchronization. The requester 301 puts device information for the requestor 301 in the responder 303. The device information transmitted from the requestor 301 includes meta-data for the requestor 301 and the responder 303 as stored at the requestor 301. The device information also includes meta-data for the meta-data data stores of the requestor 301 and the responder 303 as stored at the requestor 301. Optionally, the requestor 301 may also get device information of the responder 303. If requested, the device information of the responder 303 includes meta-data for the requestor 301 and the responder 303 as stored in the responder 303. The responder 303 device information also includes meta-data for the meta-data data stores of the requestor 301 and the responder 303 as stored at the responder 303.

After the put and optional get of device information, the requester 301 and the responder 303 request and negotiate synchronization of the meta-data data stores of the requestor 301 and the responder 303. The requester 301 then receives the result of the negotiation. The requester 301 then sends updates for the requestor meta-data data store. The responder 303 applies these updates to the copy of the requestor meta-data data store stored at the responder 303. After applying the updates, the responder 303 sends status of the updates to the requester 301, and sends updates for the responder meta-data data store.

The requester 301 applies the received updates to the copy of the responder meta-data data store at the requester 301. The requestor 301 then sends status of the applied updates to the responder 303. After synchronization of the meta-data data stores, the requester 301 and the responder can request and negotiate synchronization of another data store (e.g., application data store).

The described embodiments may be provided as a computer program product, or software, that may include a machine-readable medium having stored thereon instructions, which may be used to program a computer system (or other electronic device(s)) to perform a process according to embodiments of the invention, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

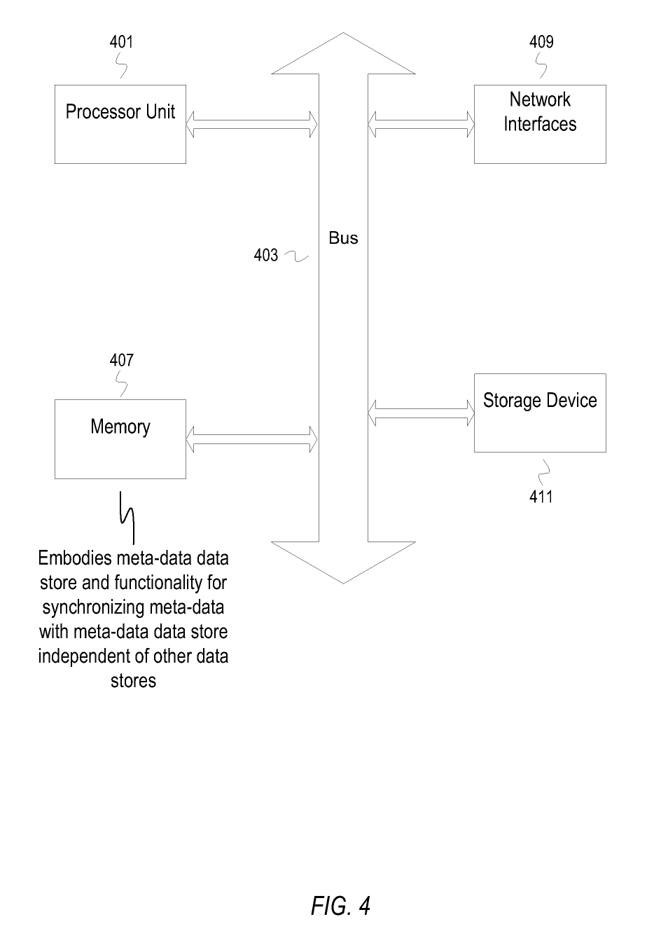

FIG. 4 depicts an example device. A device includes a processor unit 401 (possibly including multiple processors, multiple cores, multiple nodes, and/or implementing multi-threading, etc.). The device includes memory 407. The memory 407 may be system memory (e.g., one or more of cache, SRAM, DRAM, RDRAM, EDO RAM, DDR RAM, EEPROM, etc.) or any one or more of the above already described possible realizations of machine-readable media. The device also includes a bus 403 (e.g., PCI, ISA, PCI-Express, HyperTransport®, InfiniBand®, NuBus, etc.), a network interface 405 (e.g., an ATM interface, an Ethernet interface, a Frame Relay interface, SONET interface, wireless interface, etc.), and a storage device(s) 409 (e.g., optical storage, magnetic storage, etc.). The system memory 407 embodies functionality to implement embodiments described above. The system memory 407 may include one or more functionalities that facilitate maintaining a meta-data data store and/or synchronizing meta-data with a meta-data data store independent of other data stores. Any one of these functionalities may be partially (or entirely) implemented in hardware and/or on the processing unit 401. For example, the functionality may be implemented with an application specific integrated circuit, in logic implemented in the processing unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 409, and the network interface 405 are coupled to the bus 403. Although illustrated as being coupled to the bus 403, the memory 407 may be coupled to the processor unit 401.

While the embodiments are described with reference to various implementations and exploitations, it will be understood that these embodiments are illustrative and that the scope of the invention(s) is not limited to them. In general, techniques for synchronizing meta-data with a meta-data data store independent of other data stores as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. A method comprising:
maintaining a data store of meta-data for a plurality of other data stores, wherein the meta-data data store includes a plurality of meta-data data elements, wherein each of the meta-data data elements corresponds to a respective one of a plurality of data stores on a first device;
sending meta-data of the meta-data data store of the first device to a second device; and
synchronizing at least one of the plurality of meta-data data elements of the meta-data data store between the first device and the second device to synchronize the meta-data of at least one of the plurality of data stores, wherein said synchronizing of the at least one meta-data data element is independent of synchronizing of at least one of the plurality of data stores.

2. The method of claim 1 further comprising receiving meta-data of a meta-data data store from the second device.

3. The method of claim 1, wherein the at least one data store is selected from a set consisting essentially of a data store for an application supported by the devices and a data store for a folder supported by the devices.

4. The method of claim 1 further comprising determining whether both of the devices support the meta-data data store.

5. The method of claim 1, wherein the devices are selected from a set consisting essentially of a mobile communications device, a personal data assistant, a client, and a server.

6. The method of claim 1 further comprising synchronizing the at least one of the plurality of data stores between the devices.

7. The method of claim 1 further comprising synchronizing a second one of the plurality of data stores between the devices.

8. A program product encoded in one or more machine-readable media, which when executed by a set of one or more processing units causes the set of one or more processing units to perform operations that comprise:
maintaining a data store of meta-data for a plurality of other data stores, wherein the meta-data data store includes a plurality of meta-data data elements, wherein each of the meta-data data elements corresponds to a respective one of a plurality of data stores on a first device;
sending meta-data of the meta-data data store of the first device to a second device; and
synchronizing at least one of the plurality of meta-data data elements of the meta-data data store between the first device and the second device to synchronize the meta-data of at least one of the plurality of data stores, wherein said synchronizing of the at least one meta-data data element is independent of synchronizing of at least one of the plurality of data stores.

9. The program product of claim 8, wherein the operations further comprise receiving meta-data of a meta-data data store from the second device.

10. The program product of claim 8, wherein the at least one data store is selected from a set consisting essentially of a data store for an application supported by the devices and a data store for a folder supported by the devices.

11. The program product of claim 8, wherein the operations further comprise determining whether both of the devices support the meta-data data store.

12. The program product of claim 8, wherein the devices are selected from a set consisting essentially of a mobile communications device, a personal data assistant, a client, and a server.

13. The program product of claim 8, wherein the operations further comprise synchronizing the at least one of the plurality of data stores between the devices.

14. The program product of claim 8, wherein the operations further comprise synchronizing a second one of the plurality of data stores between the devices.

15. A device comprising:
a set of one or more processor units;
an interface operable to send data to another device and operable to receive data from another device; and
one or more machine-readable media having instructions encoded therein, the instructions executable by the set of one or more processor unit to cause the processor units to perform operations that comprise,
maintaining a data store of meta-data for a plurality of other data stores, wherein the meta-data data store includes a plurality of meta-data data elements, wherein each of the meta-data data elements corresponds to a respective one of a plurality of data stores on the device;
sending meta-data of the meta-data data store of the device to another device; and
synchronizing at least one of the plurality of meta-data data elements of the meta-data data store between the device and another device to synchronize the meta-data of at least one of the plurality of data stores, wherein said synchronizing of the at least one meta-data data element is independent of synchronizing of at least one of the plurality of data stores.

16. The device of claim 15, wherein the operations further comprise receiving meta-data of a meta-data data store from another device.

17. The device of claim 15, wherein the at least one data store is selected from a set consisting essentially of a data store for an application supported by the device and a data store for a folder supported by the device.

18. The device of claim 15, wherein the operations further comprise determining whether another device also supports the meta-data data store.

19. The device of claim 15, wherein the operations further comprise synchronizing the at least one of the plurality of data stores between the device and another device.

20. The device of claim 15, wherein the operations further comprise synchronizing a second one of the plurality of data stores between the device and another device.
